(19) United States
(12) Patent Application Publication
(10) Pub. No.: US 2007/0184867 A1
(43) Pub. Date: Aug. 9, 2007

(54) Establishing PT session using PT box

(75) Inventors: Sung-Mu Son, Gyeonggi-Do (KR); Kang Suk Huh, Gyeonggi-Do (KR); Jae-Seung Song, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/652,690

(22) Filed: Jan. 12, 2007

Related U.S. Application Data
(60) Provisional application No. 60/797,376, filed on May 4, 2006.
(60) Provisional application No. 60/758,211, filed on Jan. 12, 2006.

(30) Foreign Application Priority Data
Sep. 14, 2006 (KR) 89322/2006

(51) Int. Cl. H04B 7/00; H04Q 7/20

(52) U.S. Cl. 455/518

(57) ABSTRACT

A Push-To (PT) service of Session Initiation Protocol (SIP) based session services, and particularly, the method and system that even if a target PT client terminal is in the unregistered state to the SIP/IP core and a PT server has not received ‘PT service setting’ from the target PT client terminal yet, a particular PT client can use the PT box of the target PT client terminal.

This disclosure relates to a session based service, and a method and terminal for establishing a PT (Push-To) session in a Session Initiation Protocol (SIP) based service that allows a specific terminal to use a PT box service under the control of a PT server.

In wireless communications, SIP denotes a signaling protocol which defines a procedure in which terminals desiring to communicate each other identify and find their locations, and establish, release or change multimedia service sessions therebetween. Services based on the SIP (i.e., SIP based services) have a request/response structure of controlling generation, modification and termination of multimedia service sessions. Also, the SIP based services provide services by using a SIP Uniform Resource Locator (URL), which is similar to an email address, without regard to IP (Internet Protocol) addresses so as to enable identification of each user.

A Push-To (PT) service may be one of the SIP based session services. The PT service is intended to provide rapid communications for service providers and mobile communication users. Also, the PT service is a type of half duplex communication service, namely, a communication service in which one client transmits media data (e.g., talk burst or media burst) to one or more other clients with which a session has been established. The PT service can typically be a Push-to-talk Over Cellular (POC) service for transmission of voice (audio) data, a Push-To-View (PTV) service for transmission of moving picture (video) data, or a Push-To-Data (PTD) service for transmission of data.

The PT service may provide a certain client terminal to communication with a single recipient (1-to-1) or between groups of recipients as in a group chat session (1-to-many), and may use a Session Initiation Protocol (SIP) to establish a session.

Usually, the PT box service may refer to a service similar to a voice mail box of a mobile communication service.

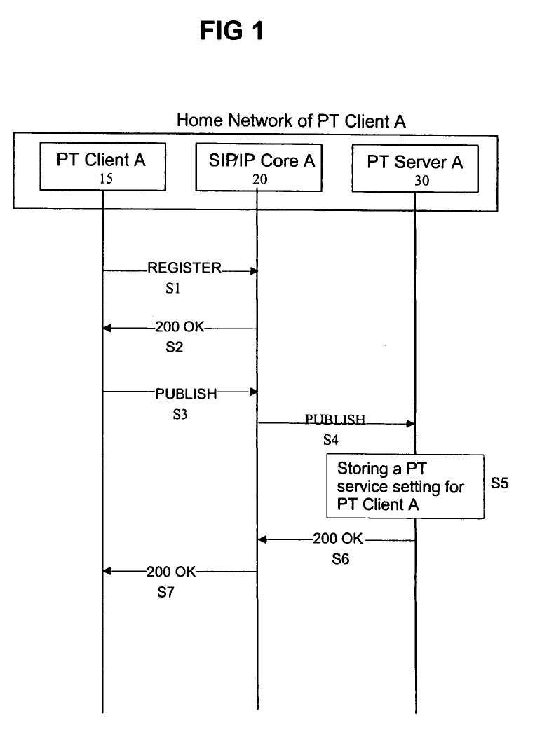

FIG. 1 is a signal flowchart illustrating a method for using a PT box service.

In FIG. 1, a PT client A may be any particular terminal (or PT User Equipment (UE)) that denotes an entity for processing or handling SIP messages. Also, messages shown in FIG. 1 are all SIP based messages.

In order to use the PT box service, several prerequisites should first be satisfied, namely, the particular terminal should be registered in a SIP/IP core and a PT service setting should be received and/or be implemented in a PT server.

As illustrated in FIG. 1, a PT client A 15 may register in a SIP/IP core A 20 (e.g., 3GPP IMS or 3GPP2 MMD) using a SIP REGISTER message (S1). The SIP/IP core A 20 may transmit a SIP 200 OK message to the PT client A 15 to inform that the PT client A 15 has successfully been registered in the SIP/IP core A 20 (S2).

The PT client A 15 may transfer set values required for the PT service (i.e., PT service setting) to a PT server A 30 via the SIP/IP core A 20 by using a SIP PUBLISH message. Here, the PT service setting may include, for example, a answer mode, an incoming session barring flag, an instant personal alert barring flag, and a simultaneous support flag, etc (S3 and S4). The PT service setting may be delivered by being included in a body or field of the SIP PUBLISH message.

The PT server A 30 may store the PT service setting therein (S5). The PT server A 30 also may inform the PT client A 15, by using the SIP 200 OK message, that the PT service setting has successfully been stored (S6 and S7). Here, in the steps of S6 and S7, the SIP 200 OK message may be delivered from the PT server 30 to the PT client A 15 via the SIP/IP core A 20.

The aforementioned steps of S1 and S2 may be referred to as a ‘registration’ process, and the steps S3 to S7 may be referred to as a ‘PT service setting’.

However, in this case, the particular terminal (i.e., the PT client A 15 in FIG. 1) may use the PT box service only after completely performing the registration process and transmitting the PT service setting to the PT server.

To address such drawbacks, there is a need for a method for using the PT box service even when a particular terminal is not able to perform a SIP/IP core registration and the PT service setting can not be transmitted to the PT server due to an unexpected power-off of the particular terminal, or even in case where the particular terminal is in an unregistered state to the SIP/IP core (IMS).

One aspect of this disclosure involves the recognition by he present inventors of such drawbacks, as explained above. Based on such recognition, improvement in establishing a PT session in a SIP based PT service for using a PT box service can be achieved. Certain features that may be part of the method and terminal for establishing the PT session in the SIP based PT service will not be described in much detail, merely to prevent the characteristics of this disclosure from being obscured. However, such additional features may also be part of the method for establishing the PT session in the SIP based session service to use the PT box service, as would be understood by those skilled in the art.

Therefore, in one embodiment, there is provided a method and terminal for establishing a PT session in a Session Initiation Protocol (SIP) based PT service in order to use a PT box service even when a particular terminal (or PT UE) has not been registered to a SIP/IP core and a PT server has not received a PTT service setting from the particular terminal.

In another embodiment, there is provided a method for establishing a PT session comprising: receiving, from a first client, a session invite message for at least one or more target terminals; checking, from a certain entity, PT box access policy conditions information related to the one or more target terminals; and transmitting the session invite message to a PT box if the PT box access condition of the target clients in the PT box access policy conditions information is satisfied.

Here, the method for establishing the PT session may further comprise: receiving a session invite response message from the PT box; and transmitting the session invite response message to the first client.

In another embodiment, a method for establishing a PT session may comprise: transmitting, by a second client, a session invite message to invite a first client; checking, by a SIP/IP core, PT box access policy conditions information related to the first client; and using, by the second client, the PT box according to the set state (setting) in the checked PT box access policy conditions information.

In another embodiment, a method for establishing a PT session may comprise: storing, by a particular client, PT box access policy conditions information in a particular entity through a first message; and transmitting, by the particular entity, a second message in response to the first message to the particular client.

In another embodiment, a method for establishing PT session may comprise, which is a method for using a PT box by which a first client checks specific data stored in the PT box, may comprise: accessing, by the first client, the PT box via a PT server by using a SIP PUBLISH message; transmitting, by the PT box, a SIP message including specific information to the first client; and transmitting, by the first client, a SIP INVITE message using the specific information in order to check the specific data stored in the PT box.

Also, there is provided a terminal which may transmit a session invite message to at least one or more target terminals, may receive the session invite message from a PT box based on PT box access policy conditions information related to the target terminals, and may receive specific data from the PT box by establishing a session with the PT box.

FIG. 1 is a signal flowchart illustrating a method for using a PT box service.

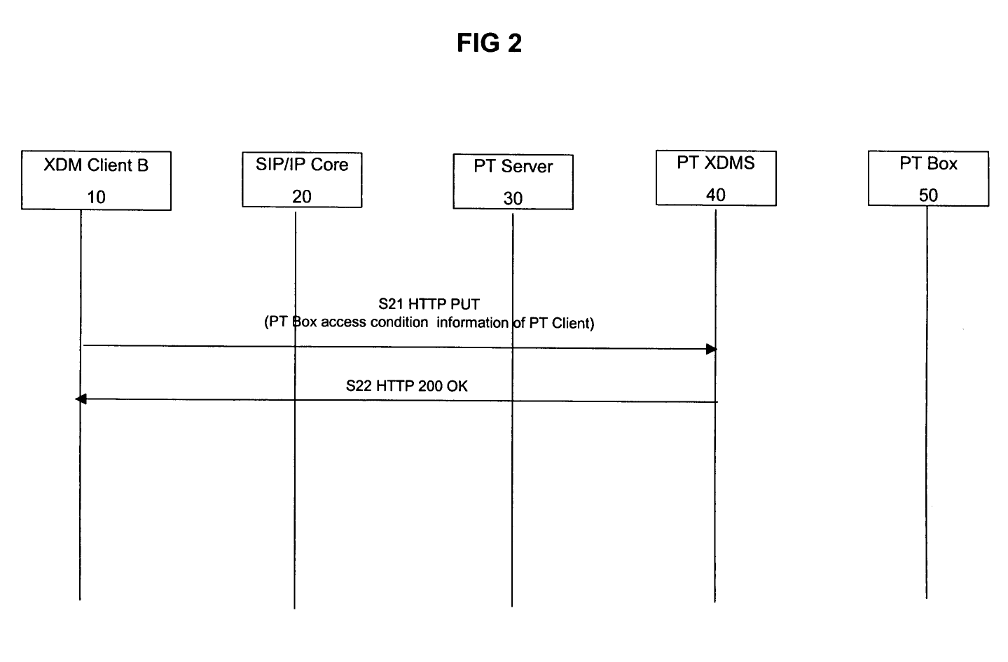

FIG. 2 is a signal flowchart illustrating a procedure of storing PT box access policy conditions information in a PT XML Database Management Server (PT XDMS) in a PT system.

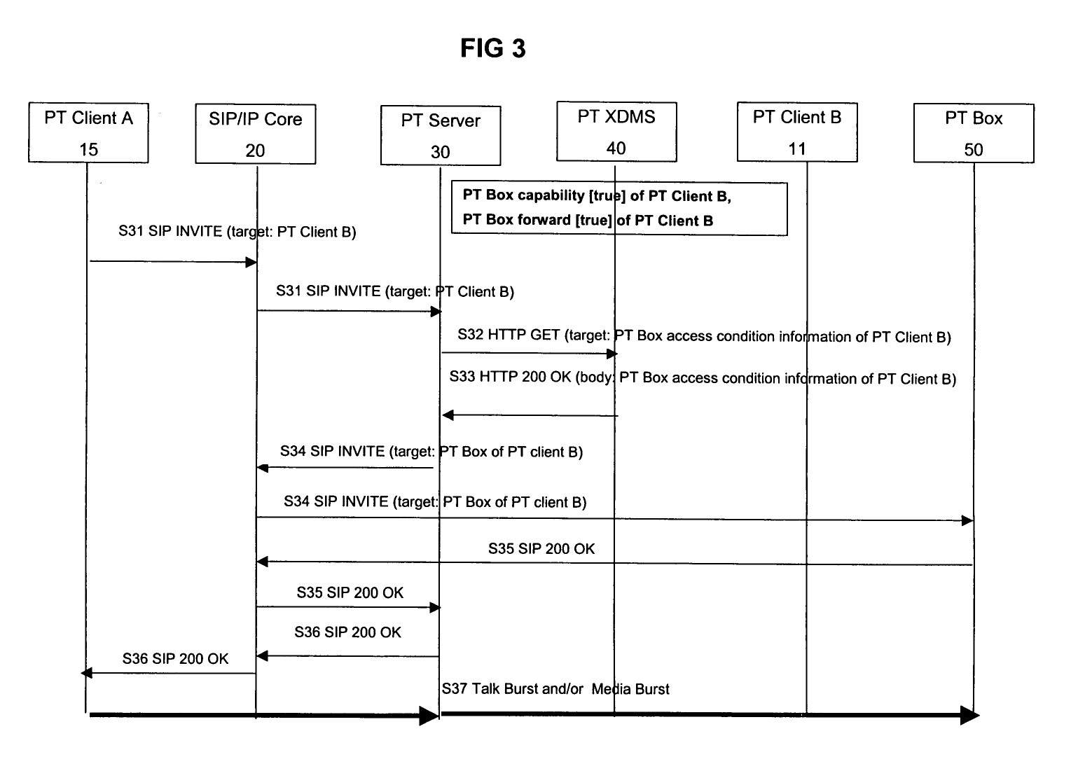

FIG. 3 is a signal flowchart illustrating a method for using a PT box in case where a PT box forward of the PT box access policy conditions information stored in the PT XDM server of the PT system is set to ‘true’.

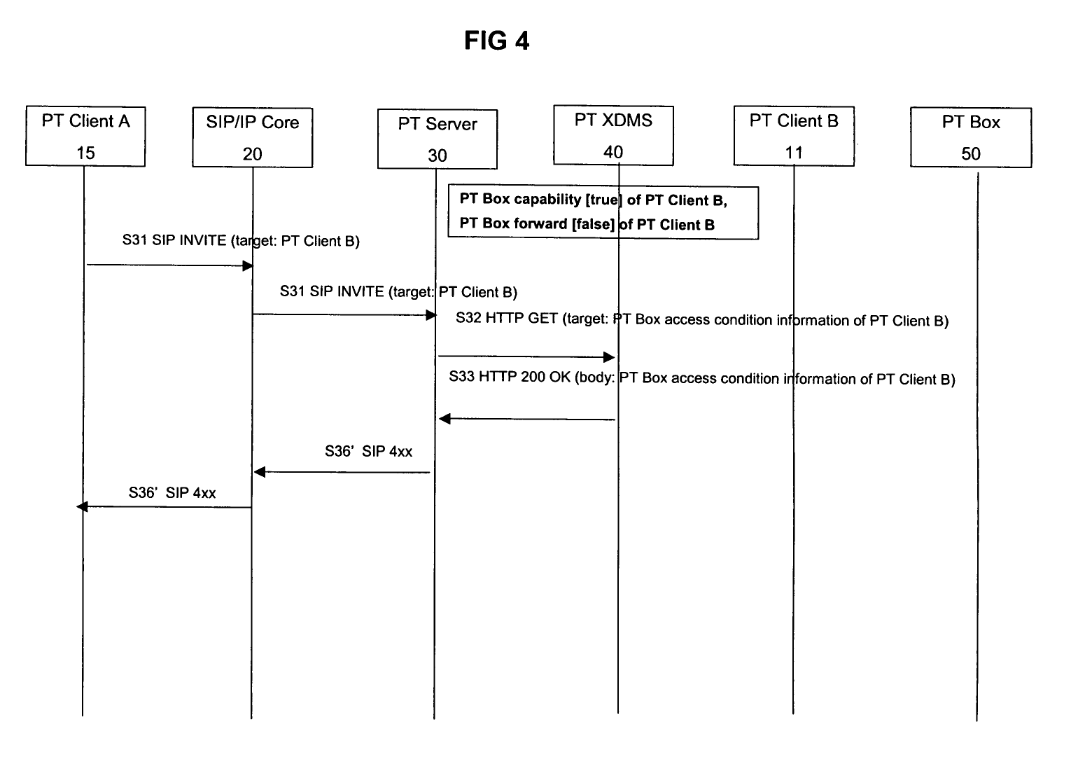

FIG. 4 is a signal flowchart illustrating a method for using a PT box in case where the PT box forward of the PT box access policy conditions information stored in the PT XDM server of the PT system is set to ‘false’.

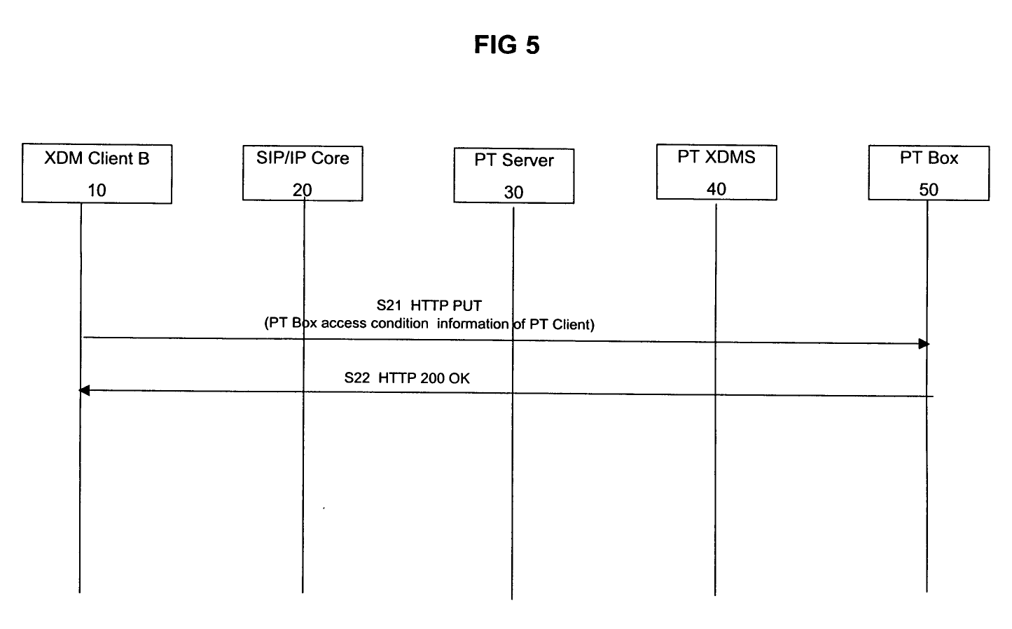

FIG. 5 is a signal flowchart illustrating a procedure of storing PT box access policy conditions information in a PT box in a PT system.

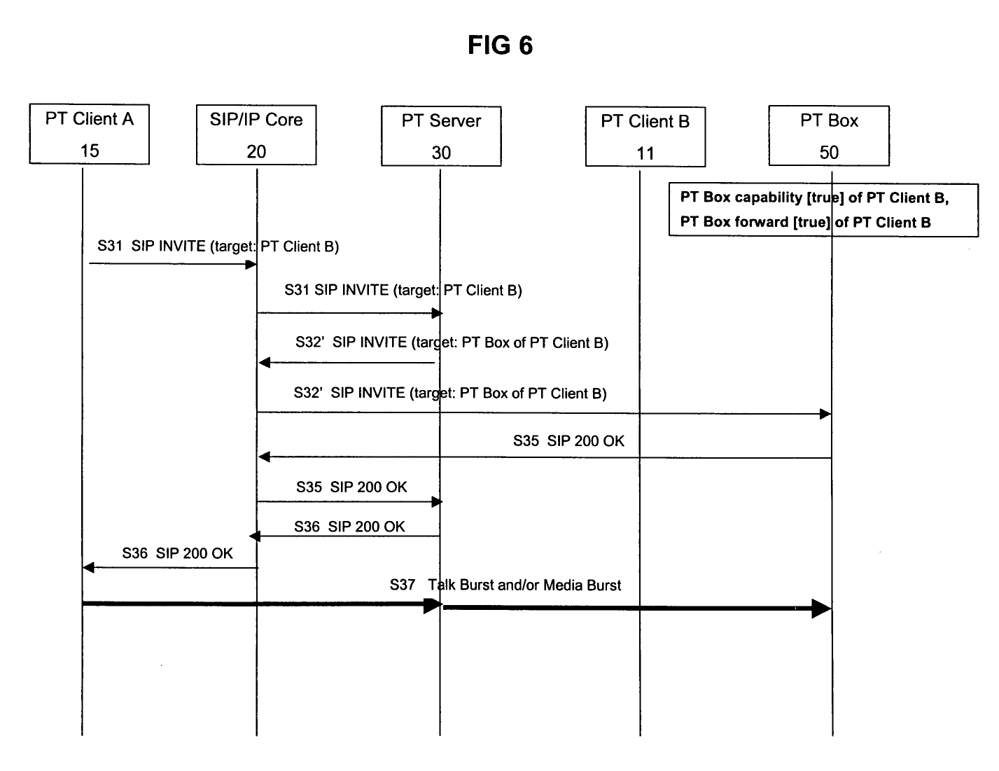

FIG. 6 is a signal flowchart illustrating a method for using a PT box in case where a PT box forward of the PT box access policy conditions information stored in the PT box of the PT system is set to ‘true’.

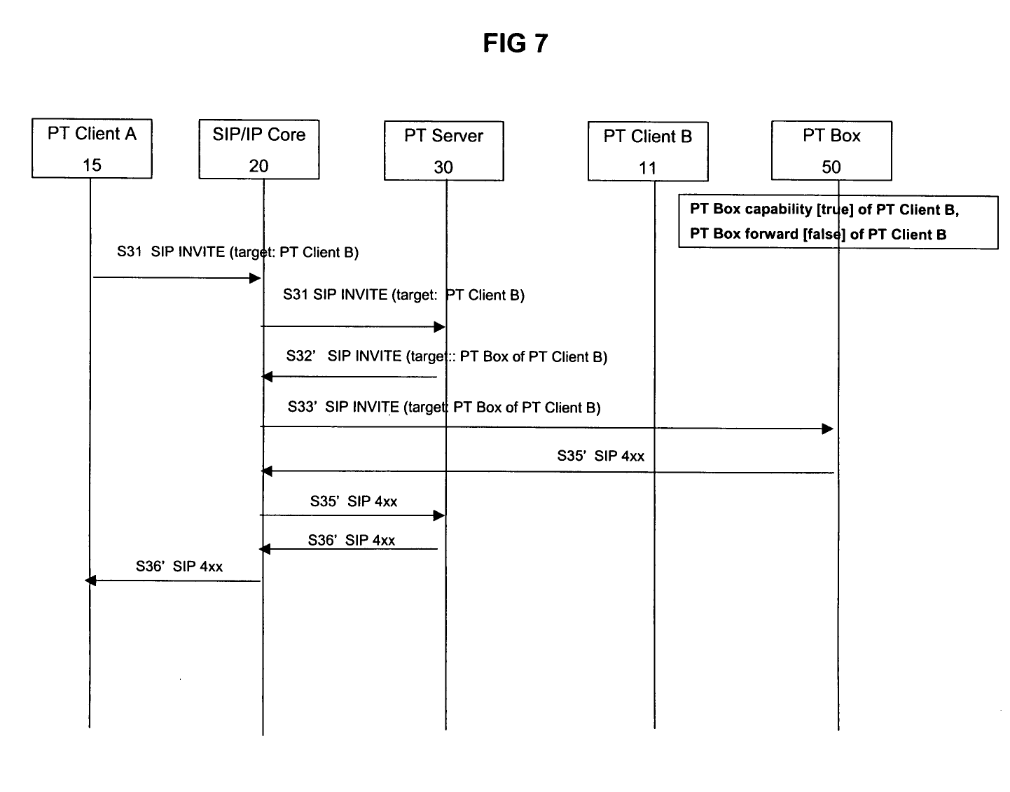

FIG. 7 is a signal flowchart illustrating a method for using a PT box in case where the PT box forward of the PT box access policy conditions information stored in the PT box of the PT system is set to ‘false’.

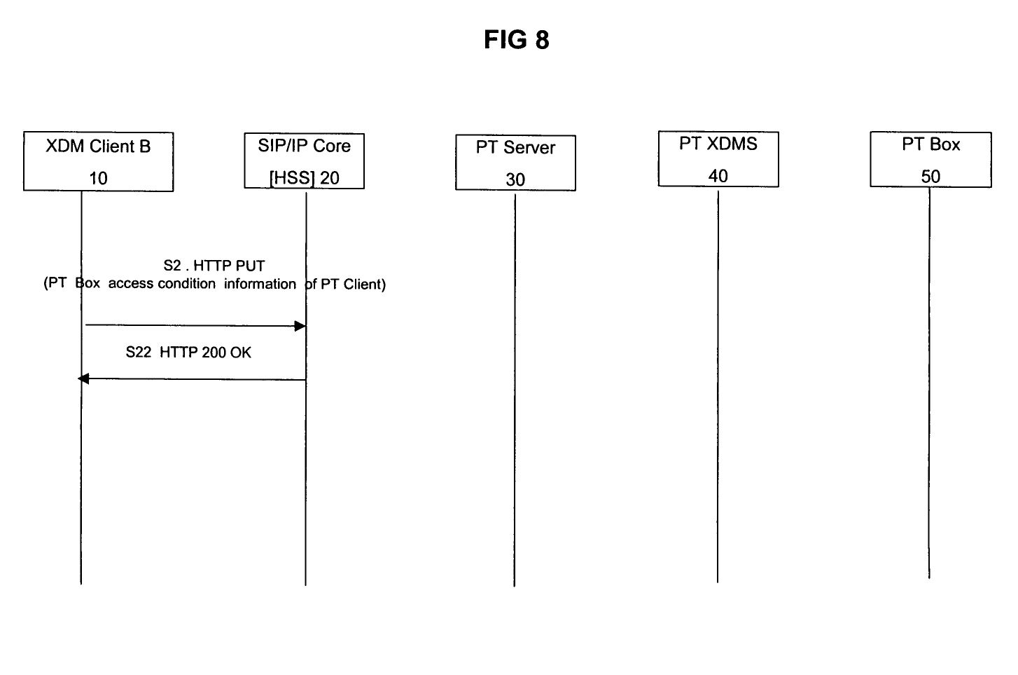

FIG. 8 is a signal flowchart illustrating a procedure of storing PT box access policy conditions information in a Home Subscribe Server (HSS) of a SIP/IP Core in a PT system.

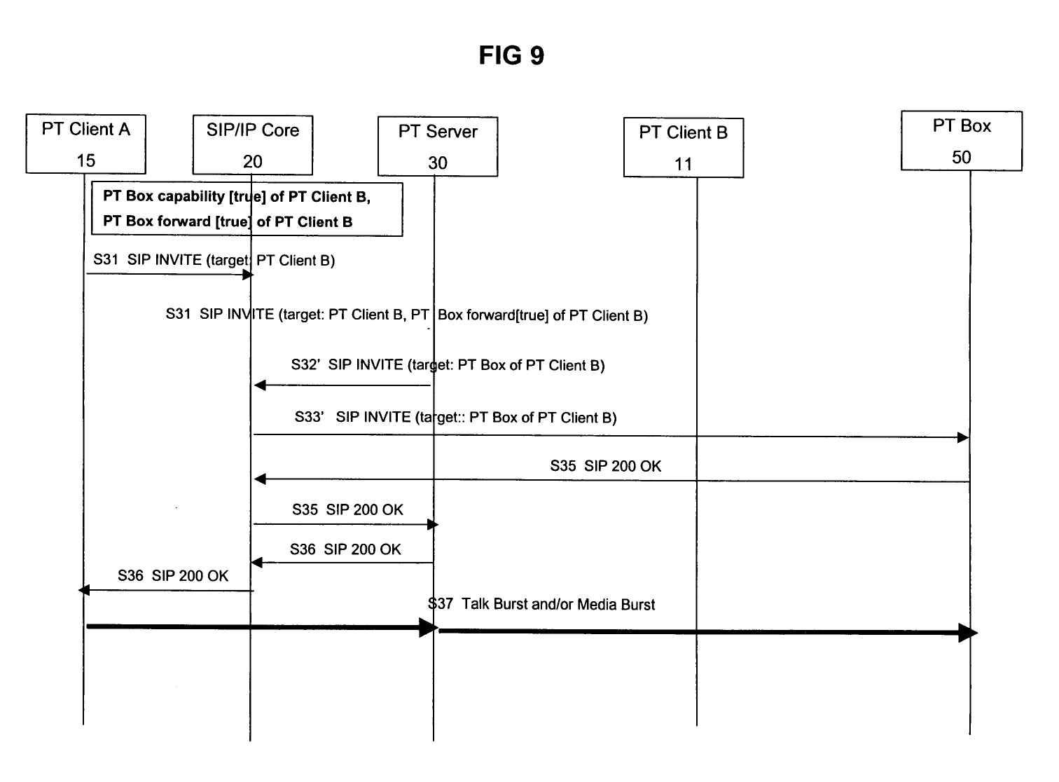

FIG. 9 is a signal flowchart illustrating a method for using a PT box in case where a PT box forward of the PT box access policy conditions information stored in the SIP/IP core of the PT system is set to ‘true’.

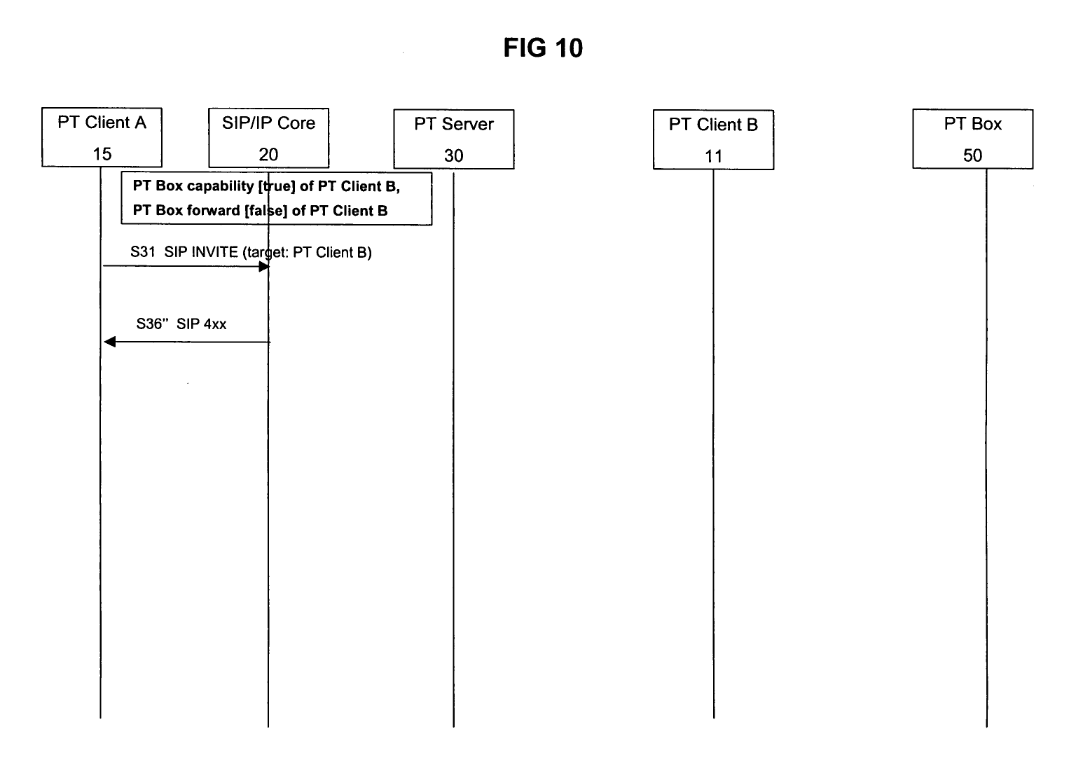

FIG. 10 is a signal flowchart illustrating a method for using a PT box in case where the PT box forward of the PT box access policy conditions information stored in the SIP/IP core of the PT system is set to ‘false’.

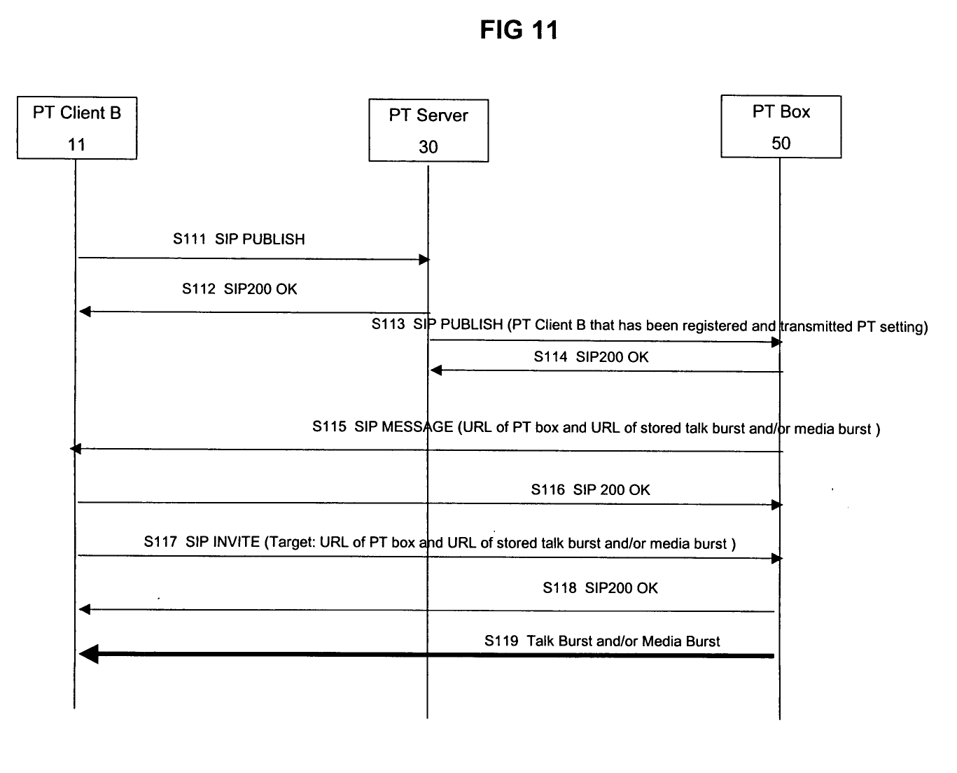

FIG. 11 is a signal flowchart illustrating a PT box notification procedure.

Hereinafter, constructions and operations of the preferred embodiments of this disclosure will be explained with reference to the accompanying drawings.

In this disclosure, in case where a counterpart (target) terminal (or a PT User Equipment (EU)) has not been registered to a SIP/IP core (i.e., an unregistered state to the SIP/IP core) and a PT server has not received a ‘PT service setting’ from the counterpart terminal, the followings are applied, namely, first, the counterpart terminal may store information related to the use of a PT box (i.e., ‘PT box access policy conditions information) in a particular entity (e.g., PT XDM server, PT box, or SIP/IP core), second, a particular terminal queries (inquires) the PT box access policy conditions information related to the counterpart terminal when the counterpart terminal is invited by the particular terminal to a PT session, third, the particular terminal may store data (e.g., talk burst or media burst) in the PT box according to the setting in the PT box access policy conditions information for the counterpart terminal, and fourth, the particular terminal may check the stored data to thusly use a PT box service.

First to fourth preferred embodiments are proposed or suggested in this disclosure. The first to third embodiments of this disclosure may be discriminated based on which entity a particular PT client would use to store its ‘PT box access policy conditions information’ in order to use a PT box. The fourth embodiment of this disclosure may illustrate that a particular terminal checks specific data stored in the PT box by a counterpart terminal.

The first to third embodiments of this disclosure may be explained or described as follows.

That is, the first embodiment of this disclosure may illustrate the PT box access policy conditions information related to a particular PT client is stored in a ‘PT XML Database Management Server (i.e., referred to as PT XDMS or PT XDM server). The second embodiment of this disclosure may illustrate the PT box access policy conditions information related to the particular PT client is stored in a PT box. The third embodiment of this disclosure may illustrate the PT box access policy conditions information related to the particular PT client is stored in a ‘SIP/IP core (particularly, in ‘HSS’).

The first through third embodiments of this disclosure assume that a PT client B has not been registered to the SIP/IP core and the PT server has not received ‘PT service setting’. Here, it can be said that the PT client terminal B may become the unregistered state to a SIP/IP core if the PT service setting has not been received from the PT client yet or the PT client has not performed an IMS (i.e., SIP/IP core) registration.

Hereinafter, the first embodiment of this disclosure will be explained with reference to FIGS. 2 to 4.

FIG. 2 is a signal flowchart illustrating a procedure of storing PT box access policy conditions information in a PT XML Database Management Server (PT XDMS) in a PT system in accordance with a first embodiment of this disclosure.

As illustrated in FIG. 2, a PT system may include a XDM client B 10 which is included in a PT UE (User Equipment) to process HTTP related messages, a SIP/IP core 20, a PT server 30, a PT XDM (XML Database Management) server 40 that may manage XML documents for the PT service, and a PT box 50 that may store voice data (i.e., talk burst) and multimedia data (i.e., media burst) for the PT service.

The XML documents managed by the PT XDM server 40 denote documents in an XML format related to user access policies, for example, may be related to PT services such as PT groups and authorization rules.

As illustrated in FIG. 2, the XDM client B may 10 transmit PT box access policy conditions information to the PT XDM server 40 (S21). And then, the PT box access policy conditions information may be transmitted from the XDM client B 10 to the PT XDM server 40 by being included in a body of a HTTP PUT message. Here, the PT box access policy conditions information may include certain information required to set whether to connect (access) a third PT UE to the PT box when the third PT UE invites a PT UE (or PT terminal) to a PT session under the condition that the PT UE has not been registered to the SIP/IP core 20 (e.g., in a power-off state of the PT UE). Such information may be referred to as ‘PT box forward’, for the sake of explanation. If it is set to connect the third PT UE to the PT box when the PT UE is in the unregistered state to the SIP/IP core 20, it may be referred to ‘PT box forward[true]’, and the opposite condition may be referred to as ‘PT box forward[false]’. Here, the unregistered state of the PT UE to the SIP/IP core 20 may indicate that the PT server 30 has not received PT service setting from the PT UE.

Also, the PT box access policy conditions information may further include information to identify whether the PT UE is a terminal (i.e., PT UE) which is capable of using the PT box service. Such information may be referred to as ‘PT box capability’, for the sake of explanation. If the PT UE is the terminal which is capable of using the PT box service, information indicating the capability of the terminal may be referred to as ‘PT box capability [true]’. On the other hand, if the PT UE is the terminal which is not capable of using the PT box service, information indicating the capability of the terminal may be referred to as ‘PT box capability[false]’. Here, this disclosure may be implemented by only using ‘PT box forward [true/false]’ information other than using the ‘PT box capability’ information. This is because that the ‘PT box forward [true/false]’ is a type of information which is available only when the ‘PT box capability’ information is true. In other words, if a terminal used by a PT user (i.e., the PT client of the user) does not support a PT box service (i.e., in case of ‘PT box capability [false]’), the PT client may not transmit the PT service setting using the PT box forward information. This is also why it is not necessary for the PT server to identify whether the PT client does not support the PT box service or whether the PT user does not want to send a message to the PT box by routing a PT session thereto.

On the other hand, those information, namely, the ‘PT box forward [true/false] and the ‘PT box capability [true/false]’ may be parameters or elements included in a body of a HTTP PUT message.

The PT XDM server 40 may store the PT box access policy conditions information related to the XDM client B 10 included in the HTTP PUT message. The PT XDM server 40 then may forward a HTTP 200 OK message to the XDM client B 10 included in the PT UE B (S20). The HTTP 200 OK message may be a message for indicating that the PT box access policy conditions information has successfully been stored in the PT XDM server 40. The PT box access policy conditions information stored in the PT XDM server 40 may not be deleted even if the XDM client B 10 logs out of a PT system or the PT UE is turned off. That is, the initially set PT box access policy conditions information keeps stored in the PT XDM server 40 until the XDM client B 10 changes the PT box access policy conditions information.

FIG. 3 is a signal flowchart illustrating a method for using a PT box in case where a PT box forward of the PT box access policy conditions information stored in the PT XDM server of the PT system is set to ‘true’.

As illustrated in FIG. 3, a PT system may further include a PT client A 15 and a PT client B 11 in addition to the construction of the PT system shown in FIG. 2. Here, the PT clients which are equipped in the PT UE denote entities for processing routing related signals. Therefore, the PT client A 15 may transmit and receive SIP messages via the SIP/IP core 20. The PT server 30 may be directly connected to the PT XDM server 40 via an interface called XCAP (e.g., HTTP).

Hereinafter, operations in the first embodiment of this disclosure will be explained with reference to FIG. 3.

In order to invite the PT client B 11 to a PT session, the PT client A 15 may transmit a SIP INVITE message (which is a session invite message sent by targeting the PT client B 11). The SIP INVITE message may be transferred (forwarded) to the PT server 30 of the PT client B 11 via the SIP/IP core 20 (S31).

The PT server 30 may receive the SIP INVITE message (i.e., the session invite message) and may check that PT service setting has not been received from the PT client B 11 which is the target of the message. That is, since the PT client B 11 is, for example, in the power-off state (i.e., a logged-out state) or in an unregistered state, the PT server 30 may check that the PT client B 11 can not currently respond with respect to the PT session invitation for the PT client B 11.

Therefore, the PT server 30 may inquire (or query) to the PT XDM server 40 as to PT box access policy conditions information related to the PT client B 11 through a HTTP GET message (S32). The PT XDM server 40 may transmit to the PT server 30 the previously stored PT box access policy conditions information (i.e., PT box forward[true]) for the PT client B 11 through a HTTP 200 OK message (i.e., a session invite response message) (S33).

The PT server 30 may check a PT box service that the PT client B 11 desires to use based on the PT box access policy conditions information (i.e., PT box forward[true]) for the PT client B 11. That is, since a parameter (i.e., a PT box forward) has been set (or is included) in the PT box access policy conditions information for the PT client B 11, the PT server 30 may identify that the PT UE including the PT client B 11 is a terminal which is capable of using the PT box service. Also, since the PT box forward has been set to ‘true’ in the PT box access policy conditions information for the PT client B 11, the PT server 30 may identify that the PT client B 11 has been set to use the PT box even if the PT server 30 has not received the PT service setting from the PT client B 11.

Therefore, based on the PT box access policy conditions information (i.e., PT box forward [true]) which has been set in FIG. 2, the PT server 30 may transmit the SIP INVITE message to invite the PT box 50 of the PT client B 11 such that the PT client A 15 can store talk burst (a type of voice mail message) or media burst (a type of multimedia message such as text, video, etc.) in the PT box 50 (S34). The SIP INVITE message which targets the PT box 50 is forwarded from the PT server 30 to the PT box 50 of the PT client B 11 via the SIP/IP core 20 (S34).

The PT box 50 may transfer a SIP 200 OK message indicating acceptance of the invitation by the PT server 30 (i.e., the step corresponding to S34) to the PT server 30 via the SIP/IP core 20 (S35). The PT server 30 then may forward the SIP 200 OK message to the PT client A 15 via the SIP/IP core 20 (S36). Here, the SIP 200 OK message may include the so-called ‘PT indicator’ in the step S35. The PT indicator may denote an indicator or parameter for informing a response of the PT box 50 of the PT client B 11 with respect to the PT session invitation by the PT client A 15. The PT indicator may be sent together with the SIP 200 OK message or by being included in the SIP 200 OK message. Also, the PT indicator may be sent either by the PT server 30 or the PT box 50.

The PT client A 15 may store, in the PT box 50, the talk burst or media burst of the PT client B 11 that it may want to have (remain) or both the talk burst and media burst (S37).

FIG. 4 is a signal flowchart illustrating a method for using a PT box in case where the PT box forward of the PT box access policy conditions information stored in the PT XDM server of the PT system is set to ‘false’.

As illustrated in FIG. 4, a process (S31) in which the PT client A 15 may transmit the SIP INVITE message to the PT client B 11, and HTTP message related processes (S32 and S33) are the same as those in FIG. 3. Thus, explanation thereof will not be repeated, but only differences between the embodiment of FIG. 4 and the embodiment of FIG. 3 will be described as follows.

The PT server 30 may check the PT box service that the PT client B 11 wants to use based on the PT box access policy conditions information (i.e., PT box forward[false]) related to the PT client B 11. That is, since the parameter (i.e., the PT box forward) has been set (or is included) in the PT box access policy conditions information for the PT client B 11, the PT server 30 may identify that the PT UE including the PT client B 11 is a terminal which is capable of using the PT box service. However, since the PT box forward has been set to ‘false’ in the PT box access policy conditions information for the PT client B 11, the PT server 30 may recognize that the PT client B 11 has been set not to use the PT box even when the PT server 30 has not received PT service setting from the PT client B 11.

Therefore, based on the PT box access policy conditions information (i.e., PT box forward [false]) which has been set in FIG. 2, the PT server 30 may transmit a failure message with respect to the session invitation (e.g., SIP 4xx message, a SIP 480 ‘temporarily unavailable’ message, etc) to the PT client A 15 such that the PT client A 15 can not store the talk burst or media burst in the PT box 50 of the PT client B 11. The SIP 4xx message may be transmitted to the PT client A 15 via the SIP/IP core 20 (S36′).

As aforementioned in the first embodiment of this disclosure illustrated in FIGS. 2 to 4, the PT session invitation by the PT client A 15 may be connected to the PT box 50 only when the PT box access policy conditions information having set in FIG. 2, namely, the PT box forward is set to ‘true’. Then, the inviter (i.e., the PT client A 15) may store the talk burst or the media burst, or both of them in the PT box 50.

Hereinafter, a second embodiment of this disclosure will be described with reference to FIGS. 5 to 7. However, overlapped parts with the first embodiment of this disclosure may be understood by the description provided with reference to FIGS. 2 to 4, and the second embodiment of this disclosure will be explained based on differences from the first embodiment of this disclosure. Therefore, the same reference numerals in FIGS. 5 to 7 which are the same as those in FIGS. 2 to 4 show the same operations and properties.

FIG. 5 is a signal flowchart illustrating a procedure of storing PT box access policy conditions information in a PT box in a PT system.

Compared with FIG. 2, in the second embodiment illustrated in FIG. 5, the PT box access policy conditions information related to the PT client B 10 may be stored in the PT box 50 other than in the PT XDM server 40. The HTTP PUT message may target the PT box 50, and the HTTP 200 OK message may be sent by the PT box 50 (S21 and S22).

FIG. 6 is a signal flowchart illustrating a method for using a PT box in case where a PT box forward of the PT box access policy conditions information stored in the PT box of the PT system is set to ‘true’.

As illustrated in FIG. 6, the PT server 30 may receive the SIP INVITE message of the step S31 to check that the PT service setting has not been received from the PT client B 11 which is the target of the message. That is, the PT server 30 may check that the PT client B 11 can not currently response with respect to the PT session invitation.

Here, unlike the first embodiment of FIG. 3 in which the PT server 30 inquiries (or queries) to the PT XDM server 40 as to the PT box access policy conditions information for the PT client B 11 through the HTTP GET message, the second embodiment of FIG. 6 illustrates that the PT server 30 may transmit the SIP INVITE message to the PT box 50 via the SIP/IP core 20 (S32′). The PT box 50 then may deliver the previously stored PT box access policy conditions information (i.e., PT box forward[true]) for the PT client B 11 to the PT server 30 through the SIP 200 OK message (S35). In the comparison between the first embodiment of FIG. 3 and the embodiment of FIG. 6, unlike the first embodiment of FIG. 3 in which the steps S32 and S33 are performed using the HTTP messages, the corresponding steps S32′ and S35 in the second embodiment of FIG. 6 may be performed using SIP messages. Also, the second embodiment of FIG. 6 does not require the step S34 to be performed. Moreover, the series of steps (i.e., S35 to S37) of FIG. 6 are the same as those corresponding steps (i.e., S35 to S37) of FIG. 3.

FIG. 7 is a signal flowchart illustrating a method for using a PT box in case where the PT box forward of the PT box access policy conditions information stored in the PT box of the PT system is set to ‘false’.

As illustrated in FIG. 7, the series of steps (S31′ to S33′) by the SIP INVITE message are the same as those described in FIG. 6.

Hereinafter, differences between the second embodiment of FIG. 7 and the first embodiment of FIG. 4 will be explained.

The PT box 50 may check the PT box service which the PT client B 11 wants to use based on the PT box access policy conditions information (i.e., PT box forward[false]) for the PT client B 11. Accordingly, based on the PT box access policy conditions information (i.e., PT box forward [false]) having set in FIG. 5, the PT box 50 may transmit the SIP 4xx message (i.e., a SIP 480 ‘temporarily unavailable’ message) indicating refusal (failure) for the invitation of the PT server 30 (i.e., the process corresponding to the step S34) to the PT server 30 via the SIP/IP core 20 (S35′). The PT server 30 then may forward the SIP 4xx message to the PT client A 15 via the SIP/IP core 20 (S36′).

Comparing the second embodiment of FIG. 2 with the first embodiment of FIG. 4, the second embodiment of FIG. 7 is different from the first embodiment of FIG. 4 in that the SIP 4xx message is transmitted from the PT box 50 to the PT server 30 via the SIP/IP core 20 (S35′), and the SIP 4xx message is then forwarded from the PT server 50 to the PT client A 15 via the SIP/IP core 20 (S36′).

Hereinafter, a third embodiment of this disclosure will be explained with reference to FIGS. 8 to 10. However, the overlapped parts with the first embodiment of this disclosure may be understood by the description provided with reference to FIGS. 2 to 4, and the overlapped parts with the second embodiment of this disclosure may be understood by the description provided with reference to FIGS. 5 to 7. The third embodiment of this disclosure will be explained based on differences from the first and second embodiments of this disclosure. Therefore, the same reference numerals in FIGS. 8 to 10 which are the same as those in FIGS. 2 to 4 and FIGS. 5 to 7 show the same operations and properties.

FIG. 8 is a signal flowchart illustrating a procedure of storing PT box access policy conditions information in a Home Subscribe Server (HSS) of a SIP/IP Core in a PT system.

Compared to FIG. 2, in the third embodiment of this disclosure illustrated in FIG. 8, the PT box access policy conditions information for the PT client B 10 may be stored in the SIP/IP core 20, especially, in a Home Subscribe Server (HSS) of the SIP/IP core 20 other than in the PT XDM server 40 (or in the PT box 50 in case of the second embodiment of FIG. 5). Therefore, the HTTP PUT message may target the HSS of the SIP/IP core 20, and the HTTP 200 OK message may be sent by the SIP/IP core 20 (S21 and S22).

FIG. 9 is a signal flowchart illustrating a method for using a PT box in case where a PT box forward of the PT box access policy conditions information stored in the SIP/IP core of the PT system is set to ‘true’.

As illustrated in FIG. 9, in order to invite the PT client B 11 to the PT session, the PT client A 15 may transmit the SIP INVITE message to the PT client B 11 (S31).

The SIP/IP core 20 may receive the SIP INVITE message of the step S31, and may check the PT box access policy conditions information related to the PT client B 11 stored in the HSS. Here, the SIP/IP core 20 may check that the PT box access policy conditions information for the PT client B 11 having stored therein in FIG. 8, namely, the PT box forward has been set to ‘true’. Hence, the SIP/IP core 20 may transmit the SIP INVITE message to the PT server 30 even if the PT client B 11 has not been registered to the SIP/IP core 20 yet (S32). The SIP INVITE message in the step S32 may include specific information indicating that the PT client A 15 should be connected to the PT box 50 of the PT client B 11.

Moreover, the series of steps (i.e., S32′ to S37) by the series of SIP messages illustrated in FIG. 9 are the same as the corresponding steps illustrated in FIG. 6 (i.e., S32′ to S37 of FIG. 6).

FIG. 10 is a signal flowchart illustrating a method for using a PT box in case where the PT box forward of the PT box access policy conditions information stored in the SIP/IP core of the PT system is set to ‘false’.

As illustrated in FIG. 10, in order to invite the PT client B 11 to the PT session, the PT client A 15 may transmit the SIP INVITE message to the PT client B 11 (S31). The SIP/IP core 20 may receive the SIP INVITE message of the step S31 to check the PT box access policy conditions information of the PT client B 11 stored in the HSS. Here, the SIP/IP core 20 may check the setting of the PT box access policy conditions information for the PT client B 11 having stored in the HSS (i.e., whether the PT box forward has been set to ‘false’).

Based on that setting of PT box access policy conditions information of the PT client B 11, if the PT client B 11 has not been registered to the SIP/IP core 20 yet (i.e., in an unregistered state to the SIP/IP core 20), the SIP/IP core 20 may determine that the inviter (i.e., the PT client A 15) would not be connected to the PT box 50 of the PT client B 11. Accordingly, the SIP/IP core 20 may send the SIP 4xx message (i.e., a SIP 480 ‘temporarily unavailable’ message) to the PT client A 15 (S36″).

As aforementioned, the first to third embodiments of this disclosure have illustrated the PT box access policy conditions information including the parameters (i.e., the PT box capability and the PT box forward). However, the first to third embodiments of this disclosure may be applied to a case where the PT box access policy conditions information includes only the PT box forward excepting the PT box capability. This may be applicable in that even if the PT box capability is set to any one of ‘true’ or ‘false’, the set state (setting) of the PT box access policy conditions information is determined according to the setting of the PT box forward. That is, if the PT box forward is set to ‘true’, the PT client A 15 can use the PT box service. On the other hand, if the PT box forward is set to ‘false’, the PT client A 15 can not use the PT box service.

FIG. 11 is a signal flowchart illustrating a PT box notification procedure in accordance with a fourth embodiment.

FIG. 11 illustrates a procedure that the talk burst or media burst (or both), which the PT client A 15 has stored in the PT box 50 of the PT client B 11 in the first to third embodiments of this disclosure, is checked by the PT client B 11.

As illustrated in FIG. 11, after the PT client B 11 in the unregistered state to the SIP/IP core 20 (not shown in FIG. 11) registers to the SIP/IP core 20, the PT client B 11 may transfer the PT service setting to the PT server 30 using the SIP PUBLISH message (S111). That is, through the step S111, the PT server 30 may recognize that the PT client B 11 is available to use the PT service (i.e., in the PT service available state). Therefore, the PT server 30 may transmit the SIP 200 OK message to the PT client B 11 (S112). Here, the SIP 200 OK message may denote the successful reception of the SIP PUBLISH message of the step S111.

The PT server 30 may transmit the SIP PUBLISH message to the PT box 50 of the PT client B 11 to inform that the PT client B 11 is currently in the PT service available state (i.e., the PT client B has been registered and completed the PT service setting in FIG. 11) (S113). The PT box 50 then may transmit the SIP 200 OK message indicating the successful reception of the SIP PUBLISH message of the step S113 to the PT server 30 (S114).

If there is the talk burst or media burst (or both) stored for the PT client B 11, the PT box 50 may transmit a SIP message (e.g., SIP MESSAGE METHOD) which includes specific information for allowing the PT client B 11 to check the talk burst or media burst (or both of them) stored by the PT client A 15 (not shown in FIG. 11) (S115). Here, the specific information may include an address of a PT box (e.g., URL of the PT box), a position address within the PT box in which the corresponding talk burst or media burst (or both) is stored (e.g., URL of the talk burst and/or URL of the media burst), and the like.

The PT client B 11 may receive the SIP message of the step S115, and then may transmit the SIP 200 OK message to the PT box 50 to inform the successful reception of the SIP message (S116).

The PT client B 11 may transmit the SIP INVITE message to the PT box 50 in order to be connected to the PT box 50 by using the specific information included in the SIP message of the step S115, the specific information indicating the address of the PT box and the position address within the PT box in which the talk burst or media burst (or both of them) is stored (S117). In response to the SIP INVITE message of the step S117, the PT box 50 may transmit the SIP 200 OK message to the PT client B 11 to inform the successful reception of the SIP INVITE message (S118).

The PT box 50 may deliver to the PT client B 11 the talk burst or media burst (or both of them) stored for the PT client B 11 (S119).

As described so far, this disclosure may provide the method and system that even if the target PT client (e.g., PT client B) is in the unregistered state to the SIP/IP core and the PT server has not received ‘PT service setting’ from the target PT client yet, a particular PT client (e.g., PT client A) can use the PT box. Specifically, this disclosure provides a method and terminal for establishing a PT session capable of allowing a particular terminal (or PT UE) to use a PT box service even in a state that the particular terminal has not been registered to a SIP/IP core and a PT server has not received a PT service setting yet, wherein in case where a counterpart terminal (or a PT User Equipment (EU)) has not been registered to a SIP/IP core (i.e., an unregistered state to the SIP/IP core) and a PT server has not received ‘PT service setting’ from the counterpart terminal, the followings are applied, namely, first, the counterpart terminal stores information related to the use of a PT box (i.e., ‘PT box access policy conditions information’) in a particular entity (e.g., PT XDM server, PT box, or SIP/IP core), second, a particular terminal queries the PT box access policy conditions information related of the counterpart terminal when inviting the counterpart terminal to a PT session, third, the particular terminal stores data (e.g., talk burst or media burst) in the PT box according to the setting in the PT box access policy conditions information of the counterpart terminal, and fourth, the particular terminal checks the stored data to thusly use a PT box service.

In addition, this disclosure may be implemented such that the target PT client can be connected to the PT box to get talk burst or media burst (or both) which is stored in the PT box for the target PT client.

In can be said that this disclosure may provide a method of handling a Push-To (PT) session service in a wireless communication system supporting a session initiation protocol (SIP), the method comprising: receiving, from a terminal, a SIP invite message to initiate a session for at least one of many target terminals; checking whether a PT service setting has been received from each of the target terminals; checking PT box access condition information associated with one or more particular target terminals, if the PT service setting has not been received from those one or more particular target terminals; determining whether to forward the SIP invite message to the PT box or to transmit a failure message to the terminal based on the checking of the PT box access condition information; transmitting a PT indicator to the terminal, wherein the PT indicator represents a response of the SIP invite message from the PT box with respect to the SIP invite message from the terminal; and transmitting at least one of talk burst and media burst to the PT box if the terminal receives the response of the SIP invite message; wherein the determining step further comprises: forwarding the SIP invite message to the PT box when the PT box access condition information is set to an unconditional PT box routing; the failure message is a SIP 480 ‘temporarily unavailable’ message; the PT box access condition information is previously stored in a certain entity of a network by the at least one of many target terminals; the PT box access condition information is retrieved from the certain entity of a network; the certain entity is at least one of a SIP/IP core, a Push-To XML Database Management Server (PT XDMS), and the PT box; and the response of the SIP invite message is a SIP 200 ‘OK’ message.

It can be also said that this disclosure may provide a method of handling a Push-To (PT) session service in a wireless communication system supporting a session initiation protocol (SIP), the method comprising: transmitting a session invite message to one or more target terminals; and receiving a session invite response message from a PT box when PT box access condition information, which is associated with one or more unregistered target terminals, is set to unconditional PT box routing; wherein the session invite response message includes an address of the PT box; the PT box access condition information is previously stored in a certain entity by the one or more target terminals; the certain entity is at least one of a SIP/IP core, a Push-To XML Database Management Server (PT XDMS), and the PT box; the session invite response message is a failure message when the PT box access condition information is not set to unconditional PT box routing; the failure message is a SIP 480 ‘temporarily unavailable’ message; the PT box access condition information is retrieved from a certain entity of a network and the certain entity is at least one of a SIP/IP core, a PT XDM server, and the PT box; the one or more unregistered target terminals are IP Multimedia Subsystem (IMS) unattached terminals; the one or more unregistered target terminals are terminals for which a server had not received a PT service setting therefrom.

This disclosure also may provide a method of handling a Push-To (PT) session service in a wireless communication system supporting a session initiation protocol (SIP), the method comprising: transmitting a SIP PUBLISH message to a PT box via a PT server; receiving, from the PT box, a SIP message that includes particular information; transmitting, to the PT box, a SIP invite message using the particular information in order to check certain data stored in the PT box; transmitting a SIP 200 OK message to the PT box in response to the received SIP message; receiving a SIP 200 Ok message from the PT box in response to the transmitted SIP invite message; and receiving the certain data stored in the PT box from the PT box; wherein the step of transmitting the SIP PUBLISH message further comprises: transmitting the SIP PUBLISH message to the PT server; and receiving a SIP 200 OK message from the PT server in response to the SIP PUBLISH message, wherein the PT server transmits the SIP PUBLISH message to the PT box then receives the SIP 200 OK message from the PT box in response to the SIP PUBLISH message; the certain data is a talk burst (TB) and/or a media burst (MB); and the particular information includes an address of the certain data stored in the PT box.

This disclosure also may provide a method of handling a Push-To (PT) session service in a wireless communication system supporting a session initiation protocol (SIP), the method comprising: receiving a SIP invite message to initiate a session for at least one of many target terminals; checking each PT service setting for each of the target terminals respectively; transmitting the SIP invite message to the PT box if the PT service setting has not been received from one or more particular target terminals; receiving a SIP invite response message from the PT box, wherein the SIP invite response message includes PT box access condition information of the one or more particular target terminals; and performing data communication through a session connection with the PT box when the PT box access condition information is set to unconditional PT box routing. Also, this disclosure may provide a method of handling a Push-To (PT) session service in a wireless communication system supporting a session initiation protocol (SIP), the method comprising: receiving a request from a client in order to initiate a session for at least one of many target clients; checking storage entity access information for one or more unregistered target clients or at least one of unavailable target terminals; determining whether to send the request to a storage entity or to send a failure message to the client according to the checking step; receiving a response of the request with respect to the request that was sent to the storage entity by the determining step; and performing data communication through a session connection with the storage entity when the storage entity access information is set to unconditional storage entity forwarding; wherein the storage entity stores session data; and the one or more unregistered target clients are terminals for which a server had not received a PT service setting therefrom.

The exemplary methods described thus far may be implemented in software, hardware, or a combination thereof. For example, the exemplary methods or at least some of the procedures thereof may be stored in storage media (e.g., internal memory of a mobile terminal, Flash memory, hard disc, etc.), and be implemented as codes, commands, instructions, etc. that are part of software programs that can be executed by processors (e.g., a microprocessor in a mobile terminal, a controller, etc.).

The client terminals mentioned above may include a transceiver module, an output unit (e.g., a display, a sound output device, etc.), an input unit (e.g., a microphone, a key input unit, etc.), a camera module, as well other control circuitry or components. Also, the server may include a network interface, a storage medium, a processor, as well as other network entities.

Also, the features and aspects described herein are related to and can be implemented for any wireless communication systems using mobile devices, such as PDAs and Laptop computers equipped with wireless communication capabilities (i.e., interface). Moreover, the use of certain terms to describe this disclosure should not limit the scope of this disclosure to a certain type of wireless communication system. This disclosure is also applicable to other wireless communication systems using different air interfaces and/or physical layers, for example, TDMA, CDMA, FDMA, WCDMA, OFDM, EV-DO, Mobile Wi-Max, Wi-Bro, etc.

It should also be understood that the above-described exemplary embodiments are not limited by any of the details of the foregoing description, unless otherwise specified, but rather should be construed broadly. Any structural and/or functional changes and modifications that fall within the metes and bounds of the claims or equivalents of such metes and bounds are therefore intended to be embraced by such claims.

1. A method of handling a Push-To (PT) session service in a wireless communication system supporting a session initiation protocol (SIP), the method comprising:
receiving, from a terminal, a SIP invite message to initiate a session for at least one of many target terminals;
checking whether a PT service setting has been received from each of the target terminals;
checking PT box access condition information associated with one or more particular target terminals, if the PT service setting has not been received from those one or more particular target terminals; and
determining whether to forward the SIP invite message to the PT box or to transmit a failure message to the terminal based on the checking of the PT box access condition information.

2. The method of claim 1, wherein the determining step further comprises:
forwarding the SIP invite message to the PT box when the PT box access condition information is set to an unconditional PT box routing.

3. The method of claim 1, wherein the failure message is a SIP 480 ‘temporarily unavailable’ message.

4. The method of claim 1, wherein the PT box access condition information is previously stored in a certain entity of a network by the at least one of many target terminals.

5. The method of claim 1, wherein the PT box access condition information is retrieved from the certain entity of a network.

6. The method of claim 5, wherein the certain entity is at least one of a SIP/IP core, a Push-To XML Database Management Server (PT XDMS), and the PT box.

7. The method of claim 1, further comprising:
transmitting a PT indicator to the terminal, wherein the PT indicator represents a response of the SIP invite message from the PT box with respect to the SIP invite message from the terminal.

8. The method of claim 7, further comprising:
transmitting at least one of talk burst and media burst to the PT box if the terminal receives the response of the SIP invite message.

9. The method of claim 7, wherein the response of the SIP invite message is a SIP 200 ‘OK’ message.

10. A method of handling a Push-To (PT) session service in a wireless communication system supporting a session initiation protocol (SIP), the method comprising:
transmitting a session invite message to one or more target terminals; and
receiving a session invite response message from a PT box when PT box access condition information, which is associated with one or more unregistered target terminals, is set to unconditional PT box routing.

11. The method of claim 10, wherein the session invite response message includes an address of the PT box.

12. The method of claim 10, wherein the PT box access condition information is previously stored in a certain entity by the one or more target terminals.

13. The method of claim 12, wherein the certain entity is at least one of a SIP/IP core, a Push-To XML Database Management Server (PT XDMS), and the PT box.

14. The method of claim 10, wherein the session invite response message is a failure message when the PT box access condition information is not set to unconditional PT box routing.

15. The method of claim 14, wherein the failure message is a SIP 480 ‘temporarily unavailable’ message.

16. The method of claim 10, wherein the PT box access condition information is retrieved from a certain entity of a network and the certain entity is at least one of a SIP/IP core, a PT XDM server, and the PT box.

17. The method of claim 10, wherein the one or more unregistered target terminals are IP Multimedia Subsystem (IMS) unattached terminals.

18. The method of claim 10, wherein the one or more unregistered target terminals are terminals for which a server had not received a PT service setting therefrom.

19. A method of handling a Push-To (PT) session service in a wireless communication system supporting a session initiation protocol (SIP), the method comprising:
transmitting a SIP PUBLISH message to a PT box via a PT server;
receiving, from the PT box, a SIP message that includes particular information; and
transmitting, to the PT box, a SIP invite message using the particular information in order to check certain data stored in the PT box.

20. The method of claim 19, wherein the step of transmitting the SIP PUBLISH message further comprises:
transmitting the SIP PUBLISH message to the PT server; and
receiving a SIP 200 OK message from the PT server in response to the SIP PUBLISH message, wherein the PT server transmits the SIP PUBLISH message to the PT box then receives the SIP 200 OK message from the PT box in response to the SIP PUBLISH message.

21. The method of claim 19, wherein the certain data is a talk burst (TB) and/or a media burst (MB).

22. The method of claim 19, wherein the particular information includes an address of the certain data stored in the PT box.

23. The method of claim 19, further comprising:
transmitting a SIP 200 OK message to the PT box in response to the received SIP message.

24. The method of claim 19, further comprising:
receiving a SIP 200 Ok message from the PT box in response to the transmitted SIP invite message; and
receiving the certain data stored in the PT box from the PT box.

25. A method of handling a Push-To (PT) session service in a wireless communication system supporting a session initiation protocol (SIP), the method comprising:
receiving a SIP invite message to initiate a session for at least one of many target terminals;
checking each PT service setting for each of the target terminals respectively;
transmitting the SIP invite message to the PT box if the PT service setting has not been received from one or more particular target terminals;
receiving a SIP invite response message from the PT box, wherein the SIP invite response message includes PT box access condition information of the one or more particular target terminals.

26. The method of claim 25, further comprising:
performing data communication through a session connection with the PT box when the PT box access condition information is set to unconditional PT box routing.

27. A method of handling a Push-To (PT) session service in a wireless communication system supporting a session initiation protocol (SIP), the method comprising:
receiving a request from a client in order to initiate a session for at least one of many target clients;
checking storage entity access information for one or more unregistered target clients or at least one of unavailable target terminals; and
determining whether to send the request to a storage entity or to send a failure message to the client according to the checking step.

28. The method of claim 27, wherein the storage entity stores session data.

29. The method of claim 27, wherein the one or more unregistered target clients are terminals for which a server had not received a PT service setting therefrom.

30. The method of claim 27, further comprising:
receiving a response of the request with respect to the request that was sent to the storage entity by the determining step.

31. The method of claim 27, further comprising:
performing data communication through a session connection with the storage entity when the storage entity access information is set to unconditional storage entity forwarding.
